(19) United States
(12) Patent Application Publication
(10) Pub. No.: US 2026/0002625 A1
(43) Pub. Date: Jan. 1, 2026

(54) ANTISTATIC TUBE

(71) Applicant: NISSEI ELECTRIC CO., LTD., Shizuoka (JP)

(72) Inventors: Kinji SHIBATA, Shizuoka (JP); Yoshiharu YABUZAKI, Shizuoka (JP)

(21) Appl. No.: 18/995,707

(22) PCT Filed: Sep. 26, 2023
(86) PCT No.: PCT/JP2023/034874

§ 371 Date: Jan. 16, 2025

(30) Foreign Application Priority Data
Sep. 29, 2022 (JP) 2022-156122

(51) Int. Cl. F16L 57/00; C09D 5/24; C09D 7/40; C09D 7/61; C09D 127/18

(52) U.S. Cl. CPC F16L 57/00; C09D 5/24; C09D 7/61; C09D 7/67; C09D 7/70; C09D 127/18

(57) ABSTRACT

Provided is an antistatic tube that can achieve a uniform antistatic effect and ensure visibility of a fluid flowing through the tube. The antistatic tube includes an inner layer (10) made of a synthetic resin and a covering layer (20) that covers an outer periphery of the inner layer (10). Electrically conductive fillers having an aspect ratio are dispersed in the covering layer (20) and thickness of the covering layer (20) is set thinner than thickness of the inner layer (10). When the synthetic resin is fluororesin, the outer periphery of the inner layer (10) is a defluorinated surface and carbon nanotubes are used as the electrically conductive fillers.

### TECHNICAL FIELD

The present disclosure relates to an antistatic tube used in factory equipment, semiconductor equipment, or the like.

### BACKGROUND ART

Tubes made of a synthetic resin are used as pipes in factory equipment, semiconductor equipment, various types of industrial equipment, or the like.

A tube made of a synthetic resin usually exhibits an electrical insulating property and tends to be electrostatically charged, and when the tube is charged, there is a harmful effect on a peripheral device due to clinging dust or a spark.

Particularly, fluororesin tubes are known as tubes that are easily electrostatically charged and have high charge capacity since fluororesin tubes exhibit particularly high volume resistivity among various types of synthetic resins and are positioned on the most negative side in a triboelectric series.

On the other hand, fluororesin is excellent in properties such as heat resistance and chemical resistance, fluororesin tubes are widely used as pipes in various types of industrial equipment, and fluororesin tubes designed with an antistatic property have been proposed.

With respect to fluororesin tubes designed with an antistatic property, those disclosed in Patent Literature 1 and Patent Literature 2 are known.

A tube disclosed in Patent Literature 1 includes electrical conductors arranged in stripes on an inner periphery and an outer periphery of the tube, and electrostatic charging is reduced by electrically connecting the inner electrical conductor and the outer electrical conductor.

However, there is a problem with the tube disclosed in Patent Literature 1 that an antistatic effect is not uniform since the electrical conductors that contribute to prevention of electrostatic charging are arranged in stripes.

A tube disclosed in Patent Literature 2 is constructed of two layers consisting of an inner layer made of a thermoplastic fluorine-based resin and an external layer made of a fluorine-based resin mixed with carbon powder, and this construction reduces electrostatic charging.

In the tube disclosed in Patent Literature 2, the external layer that contributes to prevention of electrostatic charging is provided on an entire circumference of the tube, and a uniform antistatic effect can be achieved, however, since the tube is covered by the external layer colored by the carbon powder, there is a problem of reduced visibility of a fluid flowing through the tube.

### CITATION LIST

### Patent Literature

Patent Literature 1: Unexamined Japanese Patent Application Publication No. 2008-82459
Patent Literature 2: Unexamined Japanese Patent Application Publication No. H05-092531

### SUMMARY OF INVENTION

### Technical Problem

An objective of the present disclosure is to provide an antistatic tube that can achieve a uniform antistatic effect and ensure visibility of a fluid flowing through the tube.

### Solution to Problem

The present inventors have diligently studied a construction of the tube and as a result, have devised an antistatic tube that can achieve both a uniform antistatic effect and visibility inside the tube by employing the construction to be described below.
[1] An antistatic tube, including an inner layer and a covering layer that covers an outer periphery of the inner layer, wherein
the inner layer is made of a synthetic resin,
electrically conductive fillers having an aspect ratio are dispersed in the covering layer, and
thickness of the covering layer is thinner than thickness of the inner layer.
[2] The antistatic tube according to [1] described above, wherein the synthetic resin is fluororesin.
[3] The antistatic tube according to [2] described above, wherein the fluororesin is any one of PFA, FEP, or PTFE.
[4] The antistatic tube according to [2] or [3] described above, wherein the outer periphery of the inner layer is a defluorinated surface.
[5] The antistatic tube according to any one of [1] to [4] described above, wherein the covering layer is made of a second type of fluororesin.
[6] The antistatic tube according to [5] described above, wherein the second type of fluororesin is a fluoroethylene vinyl ether copolymer.
[7] The antistatic tube according to any one of [1] to [6] described above, wherein the electrically conductive fillers have an average aspect ratio of 3 or more.
[8] The antistatic tube according to any one of [1] to [7] described above, wherein the electrically conductive fillers are carbon nanotubes.
[9] The antistatic tube according to any one of [1] to [8] described above, wherein the covering layer contains 0.1 to 30 wt % of the electrically conductive fillers.
[10] The antistatic tube according to any one of [1] to [9] described above, wherein the electrically conductive fillers are exposed on an outer periphery of the covering layer or the electrically conductive fillers protrude from the outer periphery.
[11] The antistatic tube according to any one of [1] to [10] described above, wherein thickness of the covering layer is in a range of 0.1 to 3 μm.
[12] The antistatic tube according to any one of [1] to [11] described above, wherein surface resistivity is 10¹¹ Ω/sq. or less.
[13] The antistatic tube according to any one of [1] to [12] described above, wherein a light transmission rate in a thickness direction is 30% or more.

### Advantageous Effects of Invention

The antistatic tube according to the present disclosure has excellent effects to be described below.

Due to [1] described above, the covering layer that contributes to prevention of electrostatic charging is provided on the entire circumference of the tube, and the tube exhibits a uniform antistatic effect.

Due to [2] described above, the antistatic tube that is excellent in chemical resistance, heat resistance, an antifouling property, and transparency can be achieved.

Due to [3] and [4] described above, by employing fluororesin with which the outer periphery is highly activated by defluorination, strength of junction between the inner layer and the covering layer improves, and separation of the covering layer is inhibited, thereby contributing to preserving the antistatic effect.

Due to [5] and [6] described above, durability of the covering layer improves, thereby contributing to preserving the antistatic effect.

Due to [7] to [10] described above, by using electrically conductive fibrous fillers having a high aspect ratio and exposing the electrically conductive fillers on a surface of the covering layer, even if an amount of the electrically conductive fillers to be added is small, sufficient electrical conductivity can be imparted to the covering layer, which may stabilize the antistatic effect, prevent a change in color of the covering layer generated by addition of the electrically conductive fillers, thereby contributing to preserving the visibility inside the antistatic tube.

Due to [11] described above, the thickness of the covering layer that is partially responsible for reduction of the visibility is controlled, thereby contributing to preserving the visibility inside the antistatic tube.

Due to [1] to [11] described above, the antistatic tube having the antistatic performance and the light transmissive property as described above in [12] and [13] can be achieved.

### BRIEF DESCRIPTION OF DRAWINGS

FIG. 1 is a schematic diagram of an antistatic tube according to the present disclosure;

FIG. 2 illustrates light transmission rates of examples of the antistatic tube;

FIG. 3 is an explanatory diagram illustrating a test method of a flex resistance test;

FIG. 4A and FIG. 4B are images of surface conditions of an example of the antistatic tube observed before and after the flex resistance test; and

FIG. 5A and FIG. 5B are images of surface conditions of another example of the antistatic tube observed before and after the flex resistance test.

### DESCRIPTION OF EMBODIMENTS

An antistatic tube according to the present disclosure is described below with reference to the drawings.

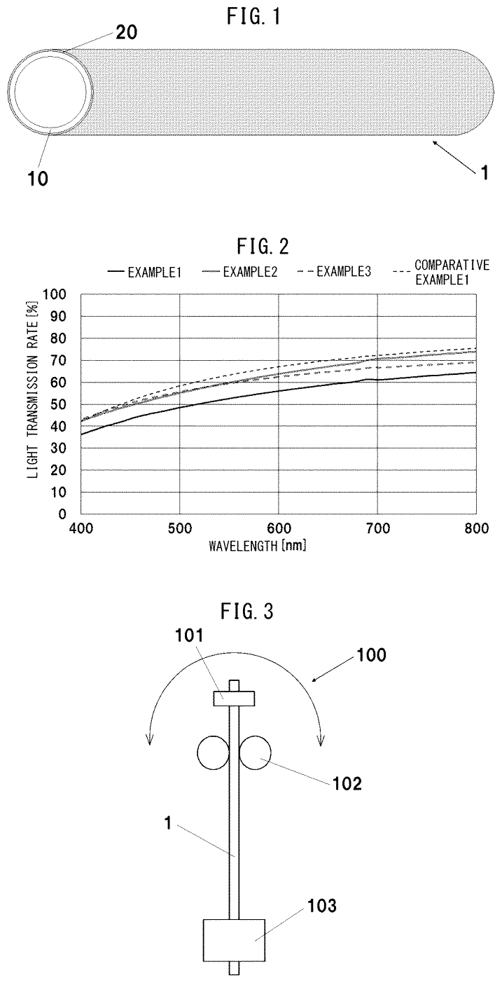

An antistatic tube 1 according to the present disclosure includes, as illustrated in FIG. 1, an inner layer 10 and a covering layer 20 that covers an outer periphery of the inner layer 10.

The antistatic tube 1 according to the present disclosure is characterized in that electrically conductive fillers having an aspect ratio are dispersed in the covering layer 20 and the covering layer 20 is shaped in such a way as to have thickness that is thinner than thickness of the inner layer 10.

With addition of the electrically conductive fillers, an antistatic effect can be imparted to the covering layer 20, and by entirely covering the outer periphery of the inner layer 10, the antistatic effect can be uniformly imparted to the antistatic tube 1 across an entire outer periphery thereof.

While transparency of the covering layer 20 is reduced by adding the electrically conductive fillers, by setting the thickness of the covering layer 20 thinner than the thickness of the inner layer 10, reduction of visibility inside the tube due to the covering layer 20 is inhibited and the visibility inside the antistatic tube 1 itself is preserved.

In the present disclosure, the inner layer 10 is made of various types of synthetic resins. Specifically, the synthetic resins include polyamide, polyolefin, polyvinyl, polyester, polyurethane, and fluororesin.

When priority is given to transparency and pressure resistance of the antistatic tube 1, polyamide may be preferably employed, more specifically, nylon 6, nylon 11, nylon 12, nylon 66, or the like.

When priority is given to transparency and flexibility of the antistatic tube 1, polyolefin may be preferably employed, more specifically, polyethylene, polypropylene, polymethylpentene, or the like.

When priority is given to chemical resistance, heat resistance, and an antifouling property of the antistatic tube 1, fluororesin may be preferably employed. Since a tube made of fluororesin is typically highly transparent and chemically stable, dissolution of impurities into a liquid flowing through the tube may be prevented.

Specifically, as the fluororesin, PTFE, PFA, FEP, ETFE, or the like may be appropriately selected from various types of fluororesin according to an application or the like of the antistatic tube 1. In the present disclosure, PFA, FEP, and PTFE are the types of fluororesin that may be particularly preferably employed.

When the inner layer 10 is made of fluororesin, the outer periphery of the inner layer 10 is preferably a defluorinated surface. Fluororesin is usually poor in adhesiveness, and it is difficult to maintain a condition in which the covering layer 20 is joined to the outer periphery of the inner layer 10.

By defluorinating the outer periphery of the inner layer 10 to achieve a defluorinated surface, adhesiveness of the outer periphery of the inner layer 10 improves and the covering layer 20 may be steadily joined, thereby contributing to preserving the uniform antistatic effect.

Defluorination of the inner layer 10 is performed using a fluororesin-based surface treatment agent such as TETRA-ETCH (manufactured by Junkosha Inc.), FluoroBonder (manufactured by Technos Corporation), a liquid ammonia solution of alkali metal, or by means of high-energy processing such as excimer laser processing or plasma processing. By such treatment or processing, fluorine atoms are extracted from polymer chains constituting the fluororesin, and adhesive functional groups such as hydroxy groups, carbonyl groups, or carboxyl groups are generated in locations where fluorine atoms have been extracted, thereby imparting adhesiveness to a surface of the fluororesin.

When the fluororesin is PFA, FEP, or PTFE, compared with other types of fluororesin, the number of fluorine atoms that cover polymer chains is relatively large, and the number of fluorine atoms to be extracted in the aforementioned treatment or processing is also large, which enables a larger number of adhesive functional groups to be generated. This contributes to improvement of strength of junction between the inner layer 10 and the covering layer 20, and as a result, contributes to preserving the uniform antistatic effect.

In the present disclosure, electrically conductive fillers having an aspect ratio are employed as fillers imparting an antistatic effect to the covering layer 20, thereby preserving the visibility inside the antistatic tube 1.

The electrically conductive fillers having an aspect ratio means here fillers having a sufficiently long dimension in a long axis direction relative to a dimension in a short axis direction, and shapes of such fillers specifically include an acicular shape, a fibrous shape, a rod shape, and a pillar shape.

Since the electrically conductive fillers having an aspect ratio have an elongated shape in the long axis direction, even if an amount of the fillers to be added is small, the electrically conductive fillers easily come into contact with each other in the covering layer 20, which stabilizes electrical conductivity in the covering layer 20.

Therefore, the amount of the electrically conductive fillers to be added in the covering layer 20 for achieving desired electrical conductivity may be small, which may prevent a change in color of the covering layer 20 generated by addition of the electrically conductive fillers, thereby contributing to preserving the visibility inside the antistatic tube 1.

An average aspect ratio of the electrically conductive fillers just has to be approximately 3 or more, and the electrically conductive fillers having the average aspect ratio of 5 or more are preferably used in order to steadily achieve the aforementioned effects. By setting the average aspect ratio in this range, contact between the electrically conductive fillers in the covering layer 20 is stabilized, and the uniform antistatic effect can be achieved.

The contact between the electrically conductive fillers is likely to stabilize as the average aspect ratio increases, and the electrically conductive fillers having the average aspect ratio of 10 or more are preferably used.

Although an upper limit of the average aspect ratio is not particularly defined, since dispersibility of the electrically conductive fillers in the covering layer 20 tends to decrease as the average aspect ratio increases, the upper limit of the average aspect ratio is preferably controlled within a range in which the dispersibility does not drastically decrease.

Specifically, as the electrically conductive fillers, carbon nanotubes may be preferably employed. Carbon nanotubes fall into a category in which the aspect ratio can be easily adjusted among various types of electrically conductive fillers, and carbon nanotubes having a high aspect ratio may be used.

In this case, the amount of the electrically conductive fillers to be added may be set within a range of 0.1 to 30 wt %, which prevents an excessive change in color of the covering layer 20, thereby contributing to preserving the visibility inside the antistatic tube 1.

For preserving the visibility inside the antistatic tube 1, the amount of the electrically conductive fillers to be added is desirably small and in a range in which a desired antistatic performance can be achieved, and the amount of the electrically conductive fillers to be added is preferably set within a range of 0.1 to 10 wt %.

When about 0.1 to 10 wt % of the electrically conductive fillers are added, the electrically conductive fillers are exposed on an outer periphery of the covering layer 20 or the electrically conductive fillers protrude from the outer periphery, which enables a certain level of antistatic performance to be achieved.

In addition to the type and the amount of the electrically conductive fillers, the thickness of the covering layer 20 and a type of the material composing the covering layer 20 are factors that are responsible for the visibility inside the antistatic tube 1.

In the present disclosure, the thickness of the covering layer 20 is preferably set within a range of 0.1 to 3 μm. By setting the thickness of the covering layer 20 sufficiently thin compared with that of the inner layer 10, reduction of the visibility inside the antistatic tube 1 due to the covering layer 20 may be minimized, thereby contributing to preserving the visibility inside the antistatic tube 1.

For stabilizing transparency and the antistatic effect of the covering layer 20, the thickness of the covering layer 20 is more preferably set within a range of 0.2 to 0.6 μm.

The material composing the covering layer 20 itself is preferably highly transparent, and an amorphous material or a material exhibiting low crystallinity may be preferably employed.

Materials having the aforementioned properties include amorphous silica, olefin, and fluororesin.

The antistatic tube 1 according to the present disclosure may be made by extrusion-molding a synthetic resin tube serving as the inner layer 10 and creating the covering layer 20 on an outer periphery of the synthetic resin tube.

Although an inside diameter and an outside diameter of the synthetic resin tube serving as the inner layer 10 are respectively set to about 2 to 25 mm and about 3 to 30 mm, these diameters are not restricted to values in these ranges and may be appropriately set according to an application of the antistatic tube 1.

When the synthetic resin is fluororesin as described above, it is desirable to perform defluorination on the outer periphery of the fluororesin tube before creating the covering layer 20.

While methods for creating the covering layer 20 include extrusion molding and coating, in light of making the thickness of the covering layer 20 thin, coating may be preferably employed in the present disclosure.

When the covering layer 20 is created by coating, a precursor solution is applied on the outer periphery of the synthetic resin tube serving as the inner layer 10, and drying and firing are performed on the synthetic resin tube, and thus, the covering layer 20 is created.

As the precursor solution, a solution is used, the solution in which a binder material serving as a material composing the covering layer 20 and electrically conductive fillers are dispersed in a solvent.

As the solvent, lower alcohol such as ethanol, propanol, or butanol may be preferably employed. Lower alcohol has lower viscosity and lower surface tension among solvents in which a binder material can be dispersed, and the outer periphery of the synthetic resin tube may be coated with lower alcohol to create a thin coating film, therefore the covering layer 20 that is thin may be created.

When the covering layer 20 is made of fluororesin, fluoroethylene vinyl ether copolymers (FEVE) may be preferably employed as the binder material.

Since FEVE has a strong binding energy that prevents degradation caused by ultraviolet light, the coating layer has high durability, thereby contributing to creation of the covering layer 20 that is rigid.

In addition, since FEVE is highly soluble in solvents and provides excellent dispersibility to pigments, the precursor solution in which the binder material and the electrically conductive fillers are uniformly dissolved and dispersed may be created, thereby contributing to achieving uniform thickness of the covering layer 20 and the uniform antistatic effect.

Among FEVE, those having FEVE alternating copolymers as main chains may be particularly preferably employed.

The solvent for using FEVE as the binder material is not particularly limited as long as the solvent can dissolve fluororesin, and in addition to lower alcohol described above, ketones such as acetone or methyl ethyl ketone, or aromatic organic solvents such as benzene, ethylbenzene, toluene, or xylene may be employed, and a single type of these solvents or two types of these solvents mixed together may be used.

The antistatic tube 1 according to the present disclosure described above can achieve both the antistatic performance and the visibility inside the tube and may be preferably used for various types of industrial equipment.

The antistatic performance is specifically evaluated as surface resistivity, and the surface resistivity of the antistatic tube 1 is set to 10¹¹ Ω/sq. or less.

A material having surface resistivity in a range of 10⁵ to 10¹¹ Ω/sq. is classified as a static dissipative material that can dissipate static electricity relatively immediately, and by setting the surface resistivity of the antistatic tube 1 to 10¹¹ Ω/sq. or less, a necessary and sufficient antistatic performance can be achieved.

More preferable surface resistivity is 10⁹ Ω/sq. or less and setting the surface resistivity to 10⁹ Ω/sq. or less may enhance dissipation of static electricity.

A material having surface resistivity of 10⁵ Ω/sq. or less is classified as a static conductive material that is not likely to be a source of static electricity, and when the surface resistivity of the antistatic tube 1 is set to 10⁵ Ω/sq. or less, dissipation of static electricity may be further enhanced and a good antistatic performance can be achieved.

The visibility inside the tube is evaluated as a light transmission rate in a thickness direction of the antistatic tube 1, and when the light transmission rate is 30% or more, visibility of a fluid passing through the tube can be ensured.

The light transmission rate just has to be in the aforementioned range in a wavelength band of 400 to 800 nm included in visible lights, and even if the light transmission rate is less than 30% at some of the wavelengths, the light transmission rate just has to be approximately 30% or more in the wavelength band of 400 to 800 nm.

### EXAMPLES

Examples of the antistatic tube 1 according to the present disclosure are given below and specifically described, but the scope of the present disclosure is not limited to those examples.

### Example 1

A PFA tube serving as the inner layer 10 having an inside diameter of 4 mm and a thickness of 1 mm was extrusion-molded, defluorination was performed on an outer periphery of the tube using TETRA-ETCH (manufactured by Junkosha Inc.), and the treated surface was cleaned.

As the precursor solution to be the covering layer 20, a solution was prepared, the solution in which an olefinic binder material and carbon nanotubes having an average aspect ratio of about 10 to 20 as the electrically conductive fillers, the carbon nanotubes being less than 1 wt %, were dispersed in a solvent having propanol as a main ingredient.

The precursor solution was applied to a surface of the PFA tube by causing the defluorinated PFA tube to pass through a tank filled with the precursor solution at a constant speed, the PFA tube was then heated for a predetermined period of time with a drying oven, and the covering layer 20 was created on the surface of the PFA tube, which completes an antistatic tube 1-1 in Example 1.

Since the solvent vaporized during heating, content of the carbon nanotubes in the covering layer 20 increased to several weight percent and the carbon nanotubes were exposed on the outer periphery of the covering layer 20. The thickness of the covering layer 20 was approximately 0.55 to 0.6 μm.

### Example 2

An antistatic tube 1-2 in Example 2 was created in a manner similar to that in Example 1 except that a mode of the covering layer 20 was modified.

As the precursor solution to be the covering layer 20, a solution was used, the solution in which amorphous silica serving as the binder material and carbon nanotubes having an average aspect ratio of about 10 to 20 as the electrically conductive fillers, the carbon nanotubes being less than 1 wt %, were dispersed in a solvent having propanol as a main ingredient.

The covering layer 20 was created in a manner similar to that in Example 1, and the antistatic tube 1-2 including the covering layer 20 having a thickness of 0.15 to 0.2 μm was obtained, in which the carbon nanotubes were exposed on the outer periphery of the covering layer 20.

### Example 3

An antistatic tube 1-3 in Example 3 was created in a manner similar to that in Example 1 except that a mode of the covering layer 20 was modified.

As the precursor solution to be the covering layer 20, a solution was prepared, the solution in which a binder material having FEVE alternating copolymers as main chains and carbon nanotubes having an average aspect ratio of about 3 to 10 as the electrically conductive fillers, the carbon nanotubes being about 1 to 2 wt %, were dispersed in a solvent having propanol as a main ingredient.

The covering layer 20 was created in a manner similar to that in Example 1, and the antistatic tube 1-3 including the covering layer 20 having a thickness of 0.15 to 0.2 μm was obtained, in which the carbon nanotubes were exposed on the outer periphery of the covering layer 20.

### Comparative Example

The PFA tube used as the inner layer 10 in Examples was assumed as Comparative Example.

### (Light Transmission Rate Evaluation Method)

By using a UV-Vis-NIR spectrophotometer “V-670” manufactured by JASCO Corporation, light transmission rates at wavelengths from 400 to 800 nm in the thickness direction were measured for the tubes in Examples and the tube in Comparative Example. FIG. 2 illustrates measurement results of the light transmission rates.

The light transmission rate of the tube in Comparative Example without the covering layer 20 was the highest with approximately 42% at the wavelength of 400 nm and approximately 75% at the wavelength of 800 nm. The light transmission rates of the tubes in Examples are considered to be better as the light transmission rates of the tubes are closer to those of the tube in Comparative Example.

The tube in Example 1 exhibited a light transmission rate of approximately 36% at the wavelength of 400 nm and a light transmission rate of approximately 65% at the wavelength of 800 nm. Although the light transmission rate is reduced due to the presence of the covering layer 20, the tube in Example 1 may be judged as having sufficient visibility in practical use.

The tube in Example 2 exhibited a light transmission rate of approximately 42% at the wavelength of 400 nm and a light transmission rate of approximately 74% at the wavelength of 800 nm. The tube in Example 2 has a light transmission rate that is close to that of the tube in Comparative Example, and the tube in Example 2 may be judged as having good visibility.

The tube in Example 3 exhibited a light transmission rate of approximately 42% at the wavelength of 400 nm and a light transmission rate of approximately 70% at the wavelength of 800 nm. Although the light transmission rate of the tube in Example 3 is inferior to that of the tube in Example 2 at longer wavelengths, the tube in Example 3 may be judged as having relatively good visibility.

### (Antistatic Performance Evaluation Method 1)

Surface potentials of the outer periphery of the tube when a fluid was caused to flow through the tube for a certain period of time were measured for the tubes in Examples and the tube in Comparative Example, and the values were used as indicators of the antistatic performance.

The tube was cut to a length of approximately 500 mm and held straight, and a gas-liquid mixed fluid was caused to flow through the tube. The gas-liquid mixed fluid was prepared by supplying ultrapure water (having electrical conductivity of 0.6 μS/cm) at a flow speed of 2 ml/min and air having a pressure of 0.1 MPa simultaneously into the tube. The test environment was kept at a temperature of 25+/−5° C. and a humidity of 20+/−5% RH.

With the surface of the tube grounded, the gas-liquid mixed fluid was caused to flow for 3 minutes or more, and the surface potential of the outer periphery of the tube was measured with a high voltage electrostatic voltmeter (Model 341B manufactured by Trek, Inc.). Measurements were made at four positions spaced 0.5 m apart in a length direction of the tube, and measurements were made four times at each position while rotating the tube in a circumferential direction (at 0°, 90°, 180°, and 270°). The measurement results are listed in Table 1.

### (Antistatic Performance Evaluation Method 2)

Test specimens having a surface condition equivalent to those of the tubes in Examples and the tube in Comparative Example were created, values of surface resistivity of the test specimens were measured, and the values were used as indicators of the antistatic performance.

As the test specimens, sheet-like specimens having an area that is sufficient for a resistivity meter to be described below to make measurements were created. Sheets were created using PFA used in Examples and Comparative Example, ones provided with a covering layer equivalent to the one in Examples were used as the test specimens for Examples while one not provided with a covering layer (that is, a PFA sheet as it is) was used as the test specimen for Comparative Example.

With respect to the test specimens for Examples, similarly to the tubes in Examples, defluorination was performed on the aforementioned PFA sheets, the treated surfaces were cleaned, the precursor solution was applied to the surfaces, and the resultant sheets were heated with a drying oven, and thus, the covering layer equivalent to those in Examples was created.

A precursor solution was applied to each of the test specimens: for the test specimen for Example 1, the precursor solution in which the olefinic binder material used in the antistatic tube 1-1 in Example 1 was dispersed; for the test specimen for Example 2, the precursor solution in which amorphous silica used in the antistatic tube 1-2 in Example 2 was dispersed; and for the test specimen for Example 3, the precursor solution in which the binder material having FEVE alternating copolymers as main chains used in the antistatic tube 1-3 in Example 3 were dispersed.

Values of surface resistivity were measured using a resistivity meter “Hiresta-UP MCP-HT450” for a high resistivity range (which is used for surface resistivity of 10⁶ Ω/sq. or more) and a resistivity meter “Loresta-IP MCP-T250” for a low resistivity range (which is used for surface resistivity of 10⁶ Ω/sq. or less), both of which were manufactured by Mitsubishi Chemical Corporation. When measurements were made using the resistivity meter for the high resistivity range, a voltage to be applied was set to 1000 V. The measurement results are listed in Table 1.

### (Antistatic Performance Evaluation Method 3)

Amounts of charge of a fluid when the fluid was caused to flow through the tube for a certain period of time were measured for the tubes in Examples and the tube in Comparative Example, and the values were used as indicators of the antistatic performance.

The tube was cut to a length of 1000 mm, and a gas-liquid mixed fluid was caused to flow through the tube. The gas-liquid mixed fluid was prepared by supplying ultrapure water (having electrical conductivity of 0.6 μS/cm) at a flow speed of 2 ml/min and air at a flow speed of 6 L/min simultaneously into the tube. The test environment was kept at a temperature of 25+/−5° C.

After the gas-liquid mixed fluid was caused to flow through for 3 minutes or more, misty ultrapure water discharged from the tube was obtained with a Faraday cup, and an amount of charge per gram of ultrapure water was calculated from an amount of charge of the Faraday cup and mass of the obtained ultrapure water. The measurement results are listed in Table 1.

TABLE 1

| | | ELECTROSTATIC POTENTIAL[V] | | | | | | | |
|---|---|---|---|---|---|---|---|---|---|
| | | | | | | AVERAGE OF | | | |
| | | | | | | ELECTROSTATIC | | | |
| | | | | | | POTENTIALS | | | AMOUNT OF |
| OBJECT | | ROTATION ANGLE IN A | | | | AT ALL | | SURFACE | CHARGE OF |
| THAT WAS | MEASUREMENT | CIRCUMFERENTIAL DIRECTION | | | | MEASUREMENT | OVERALL | RESISTIVITY | FLUID |
| MEASURED | POINT | 0° | 90° | 180° | 270° | POINTS | AVERAGE | [Ω/sq.] | [nC/g] |
| EXAMPLE1 | 1 | 10 ± 5 | 10 ± 5 | 10 ± 5 | 10 ± 5 | 10 ± 5 | 10 ± 5 | 10⁸ | 40.5 |
| | 2 | 10 ± 5 | 10 ± 5 | 10 ± 5 | 10 ± 5 | 10 ± 5 | | | |
| | 3 | 10 ± 5 | 10 ± 5 | 10 ± 5 | 10 ± 5 | 10 ± 5 | | | |
| | 4 | 10 ± 5 | 10 ± 5 | 10 ± 5 | 10 ± 5 | 10 ± 5 | | | |
| EXAMPLE2 | 1 | 10 ± 5 | 10 ± 5 | 10 ± 5 | 10 ± 5 | 10 ± 5 | 10 ± 5 | 10⁵ | 34.7 |
| | 2 | 10 ± 5 | 10 ± 5 | 10 ± 5 | 10 ± 5 | 10 ± 5 | | | |
| | 3 | 10 ± 5 | 10 ± 5 | 10 ± 5 | 10 ± 5 | 10 ± 5 | | | |
| | 4 | 10 ± 5 | 10 ± 5 | 10 ± 5 | 10 ± 5 | 10 ± 5 | | | |
| EXAMPLE3 | 1 | 10 ± 5 | 10 ± 5 | 10 ± 5 | 10 ± 5 | 10 ± 5 | 10 ± 5 | 10⁵ | 17.7 |
| | 2 | 10 ± 5 | 10 ± 5 | 10 ± 5 | 10 ± 5 | 10 ± 5 | | | |
| | 3 | 10 ± 5 | 10 ± 5 | 10 ± 5 | 10 ± 5 | 10 ± 5 | | | |
| | 4 | 10 ± 5 | 10 ± 5 | 10 ± 5 | 10 ± 5 | 10 ± 5 | | | |
| COMPARATIVE | 1 | >20,000 | | | | | | >10¹⁴ | 70.4 |
| EXAMPLE | 2 | | | | | | | | |
| | 3 | | | | | | | | |
| | 4 | | | | | | | | |

It was confirmed that the surface potentials of the tube in Comparative Example exceeded 20000 V, which is a maximum measurable value of the electrostatic voltmeter, at all measurement points and the tube was in a high-voltage charged state.

The tube in Example 1 may be judged as having an adequate antistatic performance since static electricity of about 10 V is charged at all measurement points, which means that the tube is substantially not charged.

The tube in Example 1 is judged as having an antistatic performance in terms of surface resistivity since the surface resistivity of the tube has a value from which the tube is judged as a static dissipative material.

The tube in Example 2 may be also judged as having an adequate antistatic performance since electrostatic potentials of the tube in Example 2 are equivalent to those of the tube in Example 1.

The tube in Example 2 is judged as having an adequate antistatic performance in terms of surface resistivity since the surface resistivity of the tube has a value from which the tube may be judged as a static conductive material.

The tube in Example 3 may be judged as having an adequate antistatic performance since electrostatic potentials of the tube in Example 3 are equivalent to those of the tube in Example 1.

The tube in Example 3 is judged as having an adequate antistatic performance in terms of surface resistivity since the surface resistivity of the tube has a value from which the tube may be judged as a static conductive material.

Although the amounts of charge of the fluid differ due to configurations of the covering layer 20, the amounts of charge of the fluid in Examples were reduced to about 25 to 60% of that in Comparative Example, and it may be judged that presence of the covering layer 20 is also effective in reducing charging of the fluid flowing through the tube.

### (Durability Test)

Assuming a situation in which the antistatic tube 1 according to the present disclosure is actually used, a durability test was performed on the antistatic tubes 1 in Examples. As specific indicators of durability, flex resistance and chemical resistance were evaluated.

Flex resistance was evaluated using a bending test apparatus 100 illustrated in FIG. 3. A test was performed under a condition in which the antistatic tube 1 having a length of 500 mm, an upper part of which was fixed by a fixing member 101 and to which a load 103 of 500 g was attached, was lightly held between mandrels 102 having R of 20 mm, and the antistatic tube 1 was bent 90 degrees to right and left at a rate of 30 times per minute.

Bending the tube 90 degrees to right and left was counted as one cycle, and the surface potentials of the antistatic tube 1 after 200 cycles of bending were measured in accordance with the antistatic performance evaluation method 1 and the surface condition of the bent area of the antistatic tube 1 was observed with a scanning electron microscope.

The chemical resistance was evaluated by measuring the surface potentials of a sample having a length of 500 mm that had been immersed in a test liquid for seven days in accordance with the antistatic performance evaluation method 1 described above.

As the test liquid, an organic solvent (toluene), an acid solution (37% hydrochloric acid), and a basic solution (50% sodium hydroxide aqueous solution) were used.

Results of the durability tests performed on the tubes in Example 2 and Example 3 are listed in Table 2. Electrostatic potentials listed in Table 2 are equivalent to values of overall average in Table 1.

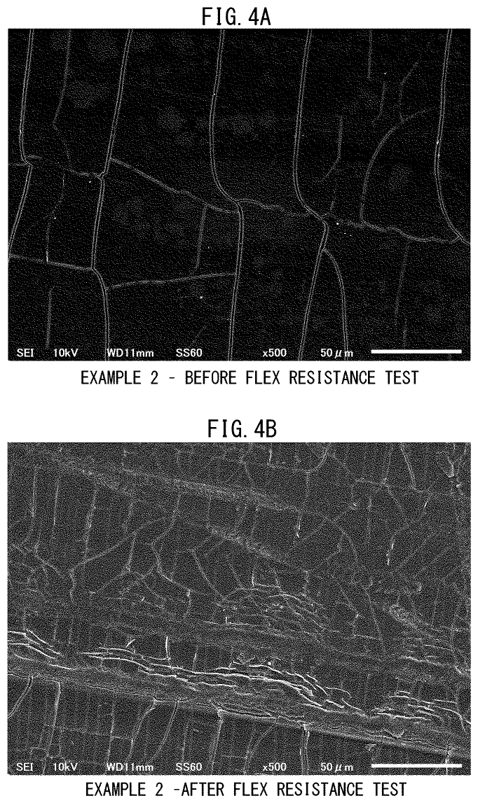

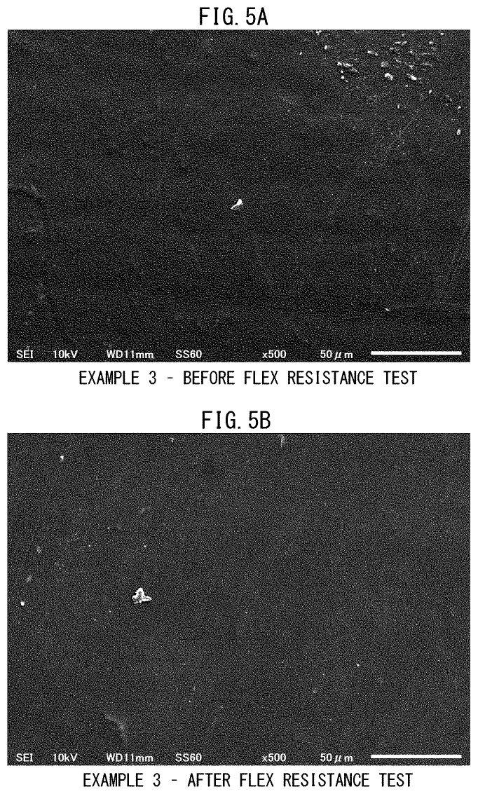

In addition, images of the surface conditions of the antistatic tubes 1 in Example 2 and Example 3 observed before and after the flex resistance test are respectively illustrated in FIGS. 4A and 4B and FIGS. 5A and 5B.

TABLE 2

| | | | CHEMICAL RESISTANCE TEST | | |
|---|---|---|---|---|---|
| | | FLEX | RESISTANCE | | |
| OBJECT THAT | | RESISTANCE | TO ORGANIC | RESISTANCE | RESISTANCE |
| WAS MEASURED | | TEST | SOLVENTS | TO ACID | TO BASE |
| EXAMPLE2 | ELECTROSTATIC | 10 ± 5 | 10 ± 5 | 10 ± 5 | 10 ± 5 |
| | POTENTIAL | | | | |
| | BEFORE TEST | | | | |
| | [V] | | | | |
| | ELECTROSTATIC | 10 ± 5 | 10 ± 5 | 10 ± 5 | >20.000 |
| | POTENTIAL | | | | |
| | AFTER TEST | | | | |
| | [V] | | | | |
| EXAMPLE3 | ELECTROSTATIC | 10 ± 5 | 10 ± 5 | 10 ± 5 | 10 ± 5 |
| | POTENTIAL | | | | |
| | BEFORE TEST | | | | |
| | [V] | | | | |
| | ERECTROSTATIC | 10 ± 5 | 10 ± 5 | 10 ± 5 | 10 ± 5 |
| | POTENTIAL | | | | |
| | AFTER TEST | | | | |
| | [V] | | | | |

In the flex resistance tests, there is no significant change in the electrostatic potentials of the tubes in Example 2 and Example 3 before and after the tests, and the tubes may be judged as having a certain level of flex resistance.

With respect to a change in the surface condition of the antistatic tube 1 before and after the flex resistance test, while cracks in the covering layer 20 progressed in the tube in Example 2, no noticeable change was observed in the tube in Example 3.

Since amorphous silica, which is a rigid material, was used as the binder material for the covering layer 20 in Example 2, it is presumed that progression of the cracks was facilitated because the covering layer 20 was rigid and could not adapt to bending. Since FEVE, which is a resin material, was used as the binder material for the covering layer 20 in Example 3, it is presumed that there was no noticeable change because the covering layer 20 had acquired a certain level of flexibility and could adapt to bending.

In the flex resistance tests that were performed in this case, degradation of the antistatic performance was not identified in Example 2, and it is presumed that an effect of the cracks generated in the covering layer 20 was minimal.

With respect to chemical resistance, since the covering layer 20 in Example 2 contains amorphous silica that is reactive to sodium hydroxide, the covering layer 20 has resistance to organic solvents and acid while the covering layer 20 does not have base resistance, and it was confirmed that the antistatic performance could be sufficiently preserved in an environment where base does not exist.

Since chemically stable fluororesin was used for the covering layer 20 in Example 3, the covering layer 20 has resistance to various types of chemicals, and it was confirmed that the antistatic performance could be sufficiently preserved in various environments.

As described above, the antistatic tube 1 according to the present disclosure may be judged as having a good antistatic performance and visibility inside the tube.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2022-156122, filed on Sep. 29, 2022, the entire disclosure of which is incorporated by reference herein.

### INDUSTRIAL APPLICABILITY

The antistatic tube according to the present disclosure can achieve both the antistatic performance and the visibility inside the tube and may be preferably used as tubes for piping in factory equipment, semiconductor equipment, or various types of industrial equipment, or the like. Specifically, such tubes include tubes for transporting a chemical for semiconductor equipment, a tube for feeding ink to an ink-jet printer, a tube used as a member of a medical device such as an endoscope or a catheter, and may be widely used in fields such as chemistry, healthcare, a pharmaceutical field, food, and analytical equipment.

### REFERENCE SIGNS LIST

1 Antistatic tube
10 Inner layer (Synthetic resin tube)
20 Covering layer

1. An antistatic tube, comprising:
an inner layer and a covering layer that covers an outer periphery of the inner layer, wherein the inner layer comprises a synthetic resin,
a plurality of electrically conductive fillers having an aspect ratio dispersed in the covering layer, and
a thickness of the covering layer is thinner than a thickness of the inner layer.

2. The antistatic tube according to claim 1, wherein the synthetic resin is a first type of fluororesin.

3. The antistatic tube according to claim 2, wherein the fluororesin is any one of PFA, FEP, or PTFE.

4. The antistatic tube according to claim 3, wherein the outer periphery of the inner layer is a defluorinated surface.

5. The antistatic tube according to claim 4, wherein the covering layer comprises a second type of fluororesin.

6. The antistatic tube according to claim 5, wherein the second type of fluororesin is a fluoroethylene vinyl ether copolymer.

7. An antistatic tube, comprising:
an inner layer and a covering layer that covers an outer periphery of the inner layer, wherein the inner layer comprises a synthetic resin,
a plurality of electrically conductive fillers having an average aspect ratio of 3 or more dispersed in the covering layer, and
a thickness of the covering layer is thinner than a thickness of the inner layer.

8. The antistatic tube according to claim 7, wherein the electrically conductive fillers are carbon nanotubes.

9. The antistatic tube according to claim 8, wherein the covering layer contains 0.1 to 30 wt % of the electrically conductive fillers.

10. The antistatic tube according to claim 9, wherein the electrically conductive fillers are exposed on an outer periphery of the covering layer or the electrically conductive fillers protrude from the outer periphery.

11. The antistatic tube according to claim 1, wherein
the thickness of the covering layer is in a range of 0.1 to 3 μm.

12. An antistatic tube, comprising:
an inner layer and a covering layer that covers an outer periphery of the inner layer, wherein the inner layer comprises fluororesin selected from a group comprising PFA, FEP, or PTFE,
the outer periphery of the inner layer is a defluorinated surface,
in the covering layer, 0.1 to 30 wt % of carbon nanotubes having an average aspect ratio of 3 or more are dispersed, and the carbon nanotubes are exposed on an outer periphery of the covering layer or the carbon nanotubes protrude from the outer periphery, and
a thickness of the covering layer is in a range of 0.1 to 3 μm.

13. The antistatic tube according to claim 12, wherein the covering layer is made of fluoroethylene vinyl ether copolymers.

14. The antistatic tube according to claim 1, wherein surface resistivity is 10¹¹ Ω/sq. or less.

15. The antistatic tube according to claim 1, wherein a light transmission rate in a thickness direction is 30% or more.

16. The antistatic tube according to claim 7, wherein surface resistivity is 10¹¹ Ω/sq. or less.

17. The antistatic tube according to claim 7, wherein a light transmission rate in a thickness direction is 30% or more.

18. The antistatic tube according to claim 12, wherein surface resistivity is 10¹¹ Ω/sq. or less.

19. The antistatic tube according to claim 12, wherein a light transmission rate in a thickness direction is 30% or more.

20. The antistatic tube according to claim 12, wherein surface resistivity is 10¹¹ Ω/sq. or less and a light transmission rate in a thickness direction is 30% or more.
